(19) United States
(12) Patent Application Publication
(10) Pub. No.: US 2007/0041059 A1
(43) Pub. Date: Feb. 22, 2007

(54) Image scanning device and method for controlling scanner output

(75) Inventors: Jesse R. Borders, Lexington, KY (US); Larry L. Kiser, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/206,401

(22) Filed: Aug. 18, 2005

(51) Int. Cl. H04N 1/46

(52) U.S. Cl. 358/504; 358/474

(57) ABSTRACT

A method for generating a quality scan by predicting scanner lamp output whenever a scanner operation is initialized. Lamp output is measured within a duration after powering on the lamp and prior to a point at which maximum lamp output is reached. The lamp output for the remaining duration of the scanning operation is predicted based on these lamp output measurements, a threshold value and the maximum lamp output. The gain of the scanner output control device is adjusted to compensate for the predicted lamp output to produce quality scan.

### FIELD OF INVENTION

The present invention generally relates to methods for predicting scanner lamp output, for example, to generate quality scans and, in one embodiment, relates to a method for generating quality scans by predicting scanner lamp output during lamp warming. The present invention further related to image scanning devices.

### BACKGROUND OF THE INVENTION

In image scanning devices, various light-emitting devices are used as the exposure lamp for image reading scanners. Cold Cathode Fluorescent (CCF) lamps are one example of an exposure lamp. CCF lamps have the advantages of relatively low cost and the ability to emit great amounts of light across a broad spectrum range, allowing images to be scanned at high speeds. However, CCF lamps typically may take from ten seconds to over sixty seconds to approach maximum light output. As such, waiting for sufficient CCF lamp output can cause a delay in generating a quality scan from the lamp-off state, which may result in reduced productivity.

Accordingly, there is a need for an image scanning device and method that allows quality scans to be generated beginning within several seconds after a scanner lamp, such as a CCF lamp, is initially powered on.

### SUMMARY OF THE INVENTION

According to the present invention, a method for generating a quality scan by predicting scanner lamp output is provided. In one embodiment of the invention, a scanner operation is initialized. A lamp output is then measured within a duration after lamp power-on and prior to a point at which maximum lamp output is reached. The lamp output for the remaining duration of the scanning operation is predicted based on these lamp output measurements, a threshold value and the maximum lamp output. The gain of the scanner output control device is adjusted to compensate for the predicted lamp output to produce a quality scan.

In accordance with another embodiment of the present invention, an image scanning device is provided. The image scanning system comprises an image scanner and a scanner output control device. A lamp is housed within the image scanner and illuminates the subject matter to be scanned. The image scanner is operable to measure the output of the lamp within a duration of time after initialization of the scanning operation and the powering on of the lamp. The image scanner predicts lamp output using a prediction algorithm based on the lamp output measurements until a maximum lamp output is achieved. The subject matter is scanned and the results are inputted into a scanner output control device. The gain of the scanner output control device is adjusted to compensate for the predicted lamp output to produce improved quality scans from the image scanner.

In accordance with yet another embodiment of the present invention, a method for generating a quality scan by predicting scanner lamp output is provided. In this embodiment, the scanner operation is initialized, and the lamp output is measured within a duration after powering on the lamp and prior to a point at which maximum lamp output is reached. The output levels of the scanner lamp are extrapolated based on the measured light output until a threshold level is reached. The lamp output for the remaining duration of the scanning operation is predicted after a threshold value is reached. The gain of the scanner output control device is switched to lower rate of increase to compensate for the predicted lamp output after the threshold value is reached. The lower rate of increase is maintained until the maximum lamp output is reached.

Accordingly, it is a feature of at least some embodiments of the present invention to enable quality scans within a few seconds and substantially before a lamp reaches its maximum output. Additionally, it is a feature of at least some embodiments of the present invention to significantly reduce the time to produce a quality first copy when a scanner is in powersave, or off, mode by predicting lamp output during the lamp-warming phase and adjusting the overall gain to compensate for rapidly increasing lamp output during an initial period of time, for example, the first minute, after powering on the lamp.

Other features of the embodiments of the present invention will be apparent in light of the description of the invention embodied herein.

### BRIEF DESCRIPTION OF THE SEVERAL VIEWS OF THE DRAWINGS

The following detailed description. of specific embodiments of the present invention may be better understood when read in conjunction with the following drawings, where like structure is indicated with like reference numerals and in which:

FIG. 1 is a graph illustrating three typical CCF lamp warming profiles according to one embodiment of the present invention.

FIG. 2 is a flow chart illustrating a prediction algorithm for CCF lamp warming according to one embodiment of the present invention.

FIG. 3 is a schematic illustration for a image scanning device according to one embodiment of the present invention.

### DETAILED DESCRIPTION

In the following detailed description of illustrative embodiments, reference is made to the accompanying drawings that form a part of the description, and in which are shown by way of illustration, and not by way of limitation, specific embodiments in which the present invention may be practiced. It is to be understood that other embodiments may be utilized and that logical, mechanical and electrical changes may be made without departing from the spirit and scope of the present invention. Particularly, while the specific embodiments discussed herein describe the use of a CCF lamp, it will be appreciated that the methods and image scanning devices of the invention may employ other types of scanning lamps as well. It will also be appreciated that the image scanning device may be a stand-alone scanning device or a component of multi-functional device, which may have the capability to fax, print, and/or copy in addition to scan.

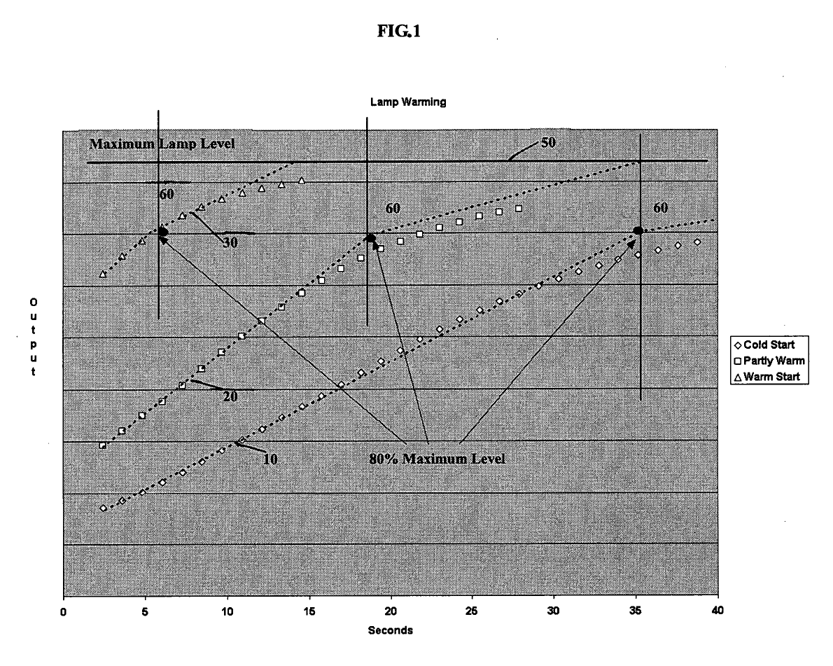

FIG. 1 is a graph illustrating three typical CCF lamp warming profiles, i.e., from a cold start 10, from a partially warm start 20 and from a warm start 30. The warming curve and the initial CCF lamp output level may vary depending on the amount of elapsed time since the CCF lamp was last turned on and off due to retained heat in the CCF lamp and surrounding material. All three curves show a reasonably linear initial warming profile even though the partially warm start 20 and warm start 30 profiles begin at higher initial output levels.

In the methods of the present invention, several measurements of CCF lamp output are made during the first few seconds after the CCF lamp is powered on. In one embodiment, the measurements can be made typically within the first five seconds after the CCF lamp is powered on. In a more specific embodiment, at least three measurements of CCF lamp output are made. In the first phase, these measurements are used to predict CCF lamp output level for the duration of the current scanning operation. To avoid unreasonably high predicted values, the calculated output levels are limited by a previously stored maximum lamp output level 50. Linear extrapolation of the CCF lamp output levels based on these measured values from the first few seconds of CCF lamp operation predicts the first phase of the CCF lamp warming cycle. In a specific embodiment, the results of the scanning operation are inputted into a scanner output control device, and the gain of the scanner output control device is adjusted to compensate for the predicted lamp output to produce good quality scans from the scanning operation.

At a threshold point 60, the linear extrapolation may begin to yield excessively high results. This threshold point 60 is a fraction of the maximum CCF lamp output 50. The threshold value at the threshold point 60 can be, for example, approximately 80-85% of the maximum output level 50 and can be empirically determined and preset for the image scanning device. At this threshold point 60, the scanner output control device switches to a lower rate of increase. This new lower rate of increase, or system gain, is based on reaching the threshold point 60 and is calculated by using a prediction algorithm.

The CCF lamp level prediction algorithm relies on an estimate of the maximum CCF lamp output level 50. The best estimate for the expected maximum CCF lamp output value is the recorded maximum CCF lamp output value from a previous CCF lamp-on cycle that lasted at least two minutes. The lower rate of increase is used until the predicted CCF lamp output reaches the expected maximum CCF lamp output level 50. At this point, the predicted CCF lamp output is set to the maximum CCF lamp output level 50. The recorded maximum CCF lamp output is maintained until the next normal calibration opportunity. The prediction algorithm and gain adjustment are applied before each scan.

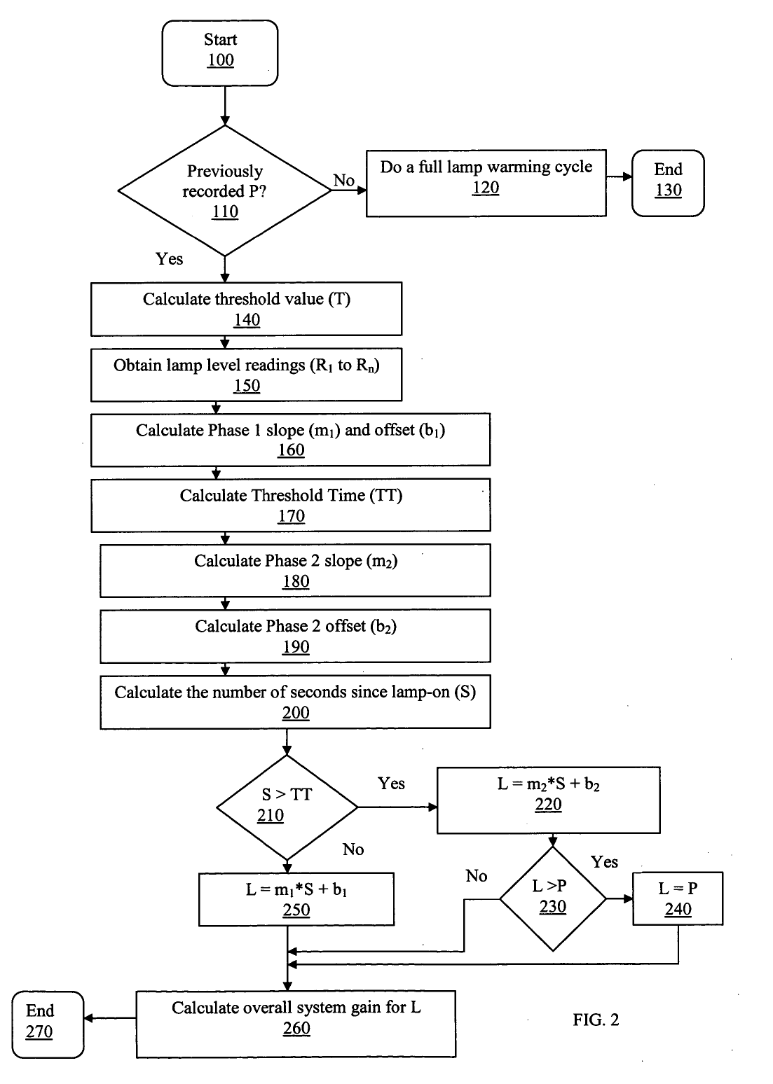

FIG. 2 is a flow chart illustrating a prediction algorithm for CCF lamp warming. The algorithm begins at block 100 upon the start of a scanning operation and the powering on of the CCF lamp of an image scanning device. Powering on means the powering on of the CCF lamp from any mode, including initial device power on and powersave mode.

The previously recorded maximum CCF lamp output level (P) is retrieved in step 110. If there is no previously recorded maximum lamp output level 50, a full lamp warming cycle is performed and that maximum CCF lamp out level P is stored in step 120. Upon the completion of the full lamp warming cycle, the scanner is ready to produce a first quality scan, and the remainder of the prediction algorithm need not be performed.

On the other hand, if a previously recorded maximum CCF lamp output level P exists, a threshold level or value (T) is calculated in step 140. The threshold value equals the product of the previously recorded maximum CCF lamp output level P and the threshold factor. The threshold factor is determined empirically and is a fraction of the previously recorded maximum CCF lamp output level determined at a point where linear extrapolation typically yields excessively high results.

In step 150, a number n of closely spaced CCF lamp output level readings (R₁ to Rₙ) are obtained within a short duration of time after the CCF lamp is powered on. In one embodiment, at least three such readings are obtained. This duration of time is typically five the best fit line through the points R₁ to Rₙ. The Phase 1 slope is determined by the change in y-direction (the output axis in FIG. 1) divided by the change in x-direction (the seconds axis in FIG. 1) of the best fit line through the points R₁ to Rₙ. The Phase 1 offset is the y-intercept point of the best fit line through the points R₁ to Rₙ, (the output axis in FIG. 1). From the Phase 1 slope and offset, the threshold time (TT) is calculated in step 170. The threshold time is the predicted time in which the CCF lamp output level should reach the threshold value. The threshold time is calculated to be the threshold value minus the Phase 1 offset divided by the Phase 1 slope.

In step 180, the Phase 2 slope (m₂) is calculated by multiplying the Phase 2 factor with the threshold time. The Phase 2 slope is the predicted change in y-direction (the output axis in FIG. 1) divided by the predicted change in x-direction (the seconds axis in FIG. 1). The Phase 2 factor is empirically determined and preset for the image scanning device based on the threshold value. In step 190, the Phase 2 offset (b₂) is then calculated by subtracting the Phase 2 slope from the threshold value and multiplying by the threshold time. The Phase 2 offset is the predicted y-intercept point.

The number of seconds (S) since the CCF lamp-on at the initialization of the scanning operation is determined in step 200. If the number of seconds since CCF lamp power-on is less than the threshold time 210, linear extrapolation is used and the predicted CCF lamp output level (L) is calculated in step 250 to be the Phase 1 slope multiplied by the number of seconds since CCF lamp-on plus the Phase 1 offset. Then, the overall system gain is calculated based on this predicted CCF lamp output level and adjusted to compensate for the predicted CCF lamp output level in step 260.

However, if the number of seconds since CCF lamp power-on is greater than the threshold time 210, the predicted CCF lamp output level is calculated to be the Phase 2 slope multiplied by the number of seconds since CCF lamp power-on plus the Phase 2 offset in step 220. If the predicted CCF lamp output level is less than the previously recorded maximum CCF lamp output level 230, the overall system gain is then calculated based on this predicted CCF lamp level in step 260. The overall system gain is adjusted to compensate for the predicted CCF lamp output level.

On the other hand, if the predicted CCF lamp output level is greater than the previously recorded maximum CCF lamp output level 230, then the predicted CCF lamp output level is set to the maximum CCF lamp output level in step 240, and the overall system gain is calculated based on this predicted CCF lamp level in step 260. The overall system gain is adjusted to compensate for the predicted CCF lamp output level.

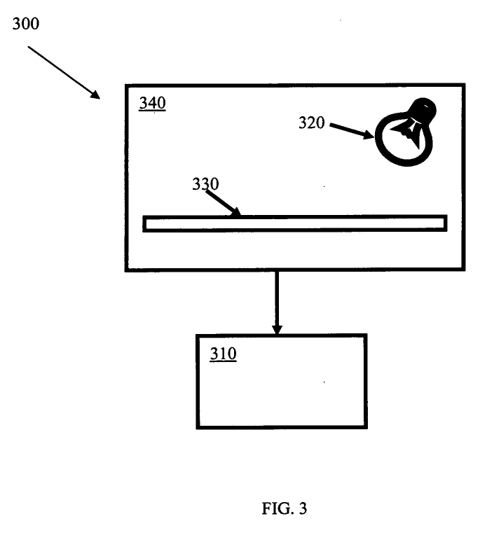

FIG. 3 is a schematic illustration for a image scanning device or system 200. The image scanning system 200 comprises an image scanner 240 and a scanner output control device 210. The image scanner 240 and scanner output control device 210 may be contained in one unit or may be housed in separate units. Housed within the image scanner 240 is a lamp 220 for illuminating subject matter 230 to be scanned. After the lamp 220 is powered on, several measurements are made of the output of the lamp 220, and a prediction algorithm is used to predict output from the lamp 220. The image scanner 240 scans the subject matter 230 and outputs the scanning information into the scanner output control device 210. The scanner output control device 210 has a variable gain to compensate for lamp output variations. Once the scanner output control device 210 receives the scanning information from the image scanner 240, the gain of the scanner output control device 210 is adjusted to compensate for the predicted output of the lamp 220 to produce quality scans from the scanning information.

Therefore, the amount of time required to complete a quality first scan after turning on the CCF lamp is greatly reduced by using the predicted CCF lamp level determined by the prediction algorithm to adjust the gain to achieve the desired scan quality. The prediction algorithm requires only the few measurements taken within the first few seconds after the CCF lamp is turned on and the previously recorded maximum CCF lamp output level.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these aspects of the invention.

What is claimed is:

1. A method for generating a quality scan by predicting scanner lamp output, comprising:
measuring lamp output of the scanner lamp within a duration after powering on of the scanner lamp and prior to maximum lamp output;
predicting lamp output for a remaining duration of the scanning operation based on the lamp output measurements, a threshold value and the maximum lamp output; and
adjusting a gain of a scanner output control device to compensate for the predicted lamp output to produce a quality scan.

2. The method of claim 1, wherein the maximum lamp output is a recorded maximum value from a previous lamp-on cycle.

3. The method of claim 2, wherein the previous lamp-on cycle is at least two minutes.

4. The method of claim 1, wherein adjusting a gain comprises:
switching to a lower rate of gain increase after the threshold value is reached; and
maintaining the lower rate of gain increase until the maximum lamp output is reached.

5. The method of claim 4, wherein the rate of gain increase is based on the amount of lamp-warming time required to reach the threshold value.

6. The method of claim 1, wherein the threshold value is a fraction of the maximum lamp output.

7. The method of claim 1, wherein the threshold value is determined empirically.

8. The method of claim 1, wherein predicting lamp output further comprises linearly extrapolating output levels of the scanner lamp based on the measured lamp output until the threshold value is reached.

9. The method of claim 8, wherein the threshold value is the point where the actual lamp output deviates from linear extrapolation of the measured lamp output.

10. The method of claim 1, wherein predicting lamp output further comprises predicting lamp output using a prediction algorithm after the threshold level is reached and before maximum lamp output is achieved.

11. The method of claim 1, wherein the scanner lamp is a cold cathode fluorescent lamp.

12. The method of claim 1, wherein the duration after powering on is no greater than five seconds.

13. The method of claim 1, wherein measuring lamp output includes making at least three measurements of the lamp output.

14. The method of claim 1, further comprising:
limiting the lamp output to the maximum light output.

15. The method of claim 1, wherein the gain adjustment is based on the amount of lamp-warming time required to reach a threshold level.

16. An image scanning device, comprising:
an image scanner;
a lamp housed within the image scanner for illuminating subject matter to be scanned by the image scanner, wherein the image scanner is operable to measure the output of the lamp within a duration of powering on the lamp and to predict lamp output using a prediction algorithm, a threshold factor and a maximum lamp output; and
a scanner output control device communicatively coupled to the image scanner, wherein the gain of the scanner output control device is adjustable to compensate for the predicted lamp output to produce quality scans.

17. The image scanning device of claim 16, wherein the prediction algorithm is operable to:
linearly extrapolate output levels of the lamp based on the measured lamp output until a threshold level has been reached; and
predict lamp output level based on the measurements of lamp output until a maximum light output is reached.

18. A method for generating a quality scan by predicting scanner lamp output, comprising:
measuring lamp output of the scanner lamp within a duration after the powering up of the scanner lamp and prior to maximum lamp output;
extrapolating output levels of the scanner lamp based on the measured light output until a threshold level is reached;
predicting lamp output for a remaining duration of the scanning operation after the threshold value is reached;
switching a scanner output control device to a lower rate of gain increase to compensate for the predicted lamp output after the threshold value is reached; and
maintaining the lower rate of gain increase of the scanner output control device until the maximum lamp output is reached.

19. The method of claim 18, further comprising:
limiting the lamp output to the maximum light output.

20. The method of claim 18, wherein the threshold level is determined at the point at which the actual lamp output deviates from the linear extrapolation of the measured lamp output.
